(19) United States
(12) Patent Application Publication
(10) Pub. No.: US 2013/0287156 A1
(43) Pub. Date: Oct. 31, 2013

(54) APPARATUS AND PROCESS FOR PENETRATION OF THE COULOMB BARRIER

(71) Applicant: Azaroghly YAZDANBOD, Calgary (CA)

(72) Inventor: Azaroghly YAZDANBOD, Calgary (CA)

(21) Appl. No.: 13/870,239

(22) Filed: Apr. 25, 2013

Related U.S. Application Data
(60) Provisional application No. 61/638,161, filed on Apr. 25, 2012.

(51) Int. Cl. G21B 1/00

(52) U.S. Cl. CPC G21B 1/00
USPC 376/137

(57) ABSTRACT

A device and method for penetrating the Coulomb barrier is disclosed. An electrode is positioned within a hollow shell, the shell enclosing an inner space containing a fusion reactive fuel such as deuterium. The inner space with the fuel is coaxially centered about the electrode, and a confinement layer made of a high dielectric strength material is located at the outer edge of the inner space, on the inside surface of the spherical shell. A high voltage power source charges the electrode, which causes a tightly packed fusion fuel nucleus cloud such as a deuteron cloud to form on the inner face of the confinement layer, facilitating coulomb barrier penetration. Using the device of the invention, conditions can also be created which enable Coulomb barrier penetration by firing nuclei towards the cloud of nuclei by applying high voltage pulses to the electrode.

### CROSS-REFERENCE TO RELATED APPLICATIONS

This application claims the benefit of U.S. Provisional application 61/638,161, filed Apr. 25, 2012, the disclosure of which is incorporated by reference in its entirety.

### FIELD OF THE INVENTION

The present invention relates generally to energy generation, and more specifically to energy generation by capacitive confinement of ions for penetration of the Coulomb Barrier as a means of effecting nuclear fusion.

### BACKGROUND OF THE INVENTION

Scientists have long dreamed of a method of producing an unlimited source of energy through controlled fusion, wherein mass is converted into energy via the famous equation E=MC². Nuclear fusion generally combines small, light nuclei to form heavier nuclei, wherein the mass of the reaction products is less than the mass of the reactants, with the difference in mass being converted to large amounts of energy. It is postulated that when the temperature of such reactants, such as deuterium and tritium gases, are raised to several million degrees Kelvin, the gas atoms can be stripped of their electrons and gain such a kinetic energy that their collisions results in nuclear fusion. This premise is being put to the test under such approaches as magnetic confinement and inertial (laser) confinement. In these approaches the reactants are heated to a plasma state and prevented from contacting the reaction chamber walls by various means as magnetic confinement to maintain the temperature and prevent damage to the chamber.

Another approach to nuclear fusion is based on accelerating the individual nuclei to high speeds and colliding them. These include various so called fusers such as Farnsworth-Hirsch fusor, in which high intensity electric fields generated between two concentric spherical electric grids are used to ionize and accelerate the reactants. Another such approach involves the use of neutron generators, in which an electric field is established between an anode and a cathode, where the cathode is a metal hydrate part used as a target. Reactant gases are ionized near the anode and are fired at deuterium- or tritium-rich metal hydrate target, resulting in fusion of the reactants. All of these approaches have been shown to result in fusion reactions, evidenced by production of fusion products such as neutrons; however, all of these suffer from low yield.

Many very innovative neutron generator designs, such as spherical and cylindrical designs, have been put to practice. A case in point is U.S. Pat. No. 7,139,349 issued to Leung, in which the anode is in the shape of hollow sphere, firing ions at a target at the center of the anode. There are also designs that use a gas between the anode and the cathode as the target, such as described in U.S. Pat. No. 6,922,455 issued to Jurezyk, et al. All such devices suffer from limited operational temperature of the target as it loses entrapped hydrogen isotopes when heated and from electron discharge from neutral atoms. The typical maximum operating temperature for metal hydride targets is typically cited to be less than 200 degrees Celsius.

Although fusion reactions do take place in devices referred to as neutron generators, they are generally not regarded as energy-generating devices due to their low yield. Higher yield devices, such as described in U.S. Pat. No. 8,090,071 to DeLuze, discloses a spherical fusion reactor with a charged central target electrode which uses an alternating polarity electric field to accelerate electrons and deuterium nuclei back and forth. DeLuze teaches that the ions gain such speed that their collisions with each other result in fusion.

While known methods and devices for creating fusion reactions may be useful for their intended purposes, there currently is no device or method for capacitive high density confinement of ions for use in penetrating the Coulomb barrier. It would therefore be beneficial to target capacitively confined ions with high temperature stability and without electrons to be tired upon by other charged nuclei with high current density as a means of effecting fusion reactions with higher yields. It would also be advantageous to provide a capacitive manipulation mechanism for confining charged nuclei at high concentrations and in very close proximity to one another, providing an environment in which the repulsive forces of the Coulomb barrier between nuclear particles can be overcome by the effect of capacitive confinement or by collision of similar particles that could be accelerated towards them. It would also be beneficial to utilize the quantum tunneling phenomena known in quantum mechanics to affect a controlled and measured rate of reaction.

### SUMMARY OF THE INVENTION

Accordingly, the present invention generally relates to an apparatus and process for confinement and concentration of positively charged nuclei (e.g. deuteron nuclei) for use in overcoming the Coulomb barrier and allowing for fusion of these nuclei to take place. The invention works under the theory that fusion of hydrogen isotope nuclei can be accomplished by the creation of very high capacitances per unit area within small-sized pores or holes on a surface herein termed a confinement layer. In one embodiment, the confined, charged nuclei can be used as targets which are fired upon by other charged nuclei as another means of penetrating the coulomb barrier. Published U.S. Patent application #2012/0097541 by the same inventor, Azaroghly Yazdanbod, which is incorporated herein by reference in its entirety, specifically teaches electric double layer capacitors, behavior of high electric capacity electrodes in confined containers, use of high electric capacity electrodes as means of capacitive generation of electric fields, and polarity reversals as means of avoiding electrode reactions at electrodes for the same. Experimental evidence and test results establishing the formation and voltage distribution of Electric Double Layer Capacitors and formation of confined ions on dielectrics as foundations of the present invention are emphasized.

A first aspect of the invention provides an apparatus for penetrating the Coulomb Barrier, comprising: (a) an electrode; (b) a hollow shell enclosing an inner space around the electrode; (c) a confinement layer made of a high dielectric strength material, the confinement layer located within the inner space on the inside surface of the shell; (d) a fusion reactive fuel contained within the inner space; (e) a direct current, positive polarity, high voltage electric power source; and (f) electrical interconnections for connecting the electric power source to the electrode and the shell to the earth ground. Typically the electrode and the hollow shell are spherical, with the electrode being centered within the shell, and the confinement layer typically has a plurality of small pores or holes on the surface thereof.

A second aspect of the invention provides a method of confining nuclei for the purpose of penetrating the Coulomb barrier, the method comprising: (a) providing a confinement layer made of a high dielectric strength material, the confinement layer lining an inner space within a multi-layered hollow shell; (b) filling the inner space with a fusion reactive fuel; and (c) charging an electrode seated within the shell, wherein the shell both encloses the inner space and is positioned around the electrode, and wherein the electrode is charged with a direct current, positive polarity, high voltage electric power source, charging of the electrode causing a positively charged nucleus cloud to form on the inner face of the confinement layer. Typically the electrode and the hollow shell are spherical, with the electrode being centered within the shell.

A third aspect of the invention provides an apparatus for capacitive confinement of nuclei as a means of penetrating the Coulomb Barrier, comprising: (a) a spherical electrode; (b) a multi-layered hollow spherical shell enclosing an inner space coaxially centered around the spherical electrode, wherein the spherical shell includes an inner spherical plane, a middle spherical plane, and an outermost spherical plane, and wherein the inner space is formed between the spherical electrode and the inner spherical plane, an inner layer is formed between the inner spherical plane and the middle spherical plane, and an outer layer is formed between the middle spherical plane and the outermost spherical plane; (c) an electrically insulated support suspending the spherical electrode fixedly and concentrically within the spherical shell; (d) a confinement layer made of a high dielectric strength material having many small diameter holes on the surface thereof, the confinement layer located within the inner space on the inside surface of the inner spherical plane; (e) a fusion reactive fuel contained within the inner space; (f) a non-conductive medium contained within the inner layer; (g) an insulating medium contained within the outer layer; (h) a direct current, positive polarity, variable, high voltage electric power source; and (i) electrical interconnections for connecting the electric power source to the spherical electrode and the outer shell to earth ground.

The nature and advantages of the present invention will be more fully appreciated from the following drawings, detailed description and claims.

### BRIEF DESCRIPTION OF THE DRAWINGS

The accompanying drawings illustrate embodiments of the invention and, together with a general description of the invention given above, and the detailed description given below, serve to explain the principles of the invention.

FIG. 1 illustrates a perspective view of one embodiment of the invention.

FIG. 2 illustrates the charge distribution within and without the embodiment shown in FIG. 1 during charging of the electrode 12.

FIG. 3 illustrates the proposed arrangement of positively charged nuclei within the small diameter holes of the confinement layer, according to the invention.

FIG. 4 illustrates two nuclei capacitively confined and in the process of fusion, according to the invention.

FIG. 5 is a graph showing pulses of high voltage administered over time in order to generate and accelerate nuclei towards the confinement layer, according to the invention.

### DETAILED DESCRIPTION OF THE INVENTION

The present invention provides an apparatus and method for confinement of positively charged nuclei (e.g. deuteron nuclei) for use in overcoming the Coulomb barrier. The cloud of nuclei so confined can also be a target to be fired upon by other nuclei generated and accelerated towards it, thereby overcoming the coulomb barrier. The Coulomb barrier is an energy harrier resulting from electrostatic interaction that two nuclei must overcome in order to approach close enough to undergo nuclear fusion. The Coulomb barrier is produced by electrostatic potential energy. In the fusion of light elements to form heavier ones, the positively charged nuclei must be forced close enough together to cause them to fuse into a single heavier nucleus. The force between nuclei is repulsive until a very small distance separates them, and then it rapidly becomes very attractive. Therefore, in order to surmount the Coulomb barrier and bring the nuclei close together where the strong attractive forces operate, the energy of the particles must overcome the repulsive energy of the Coulomb barrier.

In general, the present invention discloses fusion of positively charged nuclei, accomplished by the creation of very high charge density resulting from very high capacitance per unit area within small diameter (i.e. millimeter to micro-meter-sized) holes and/or pores on an insulating surface. This insulating surface is herein termed a confinement layer, or a fusion reaction layer. The electric field is created through high potential charging of a conductive electrode placed inside an externally grounded conductive container. The container is typically internally lined with this insulated (confinement) layer, the insulated layer having small diameter holes or pores on and near its surface. Confinement of positively charged nuclei within these holes results in increased charge density within the holes, to the extent needed for fusion reactions to take place as the Coulomb barrier between nuclei is overcome. Further, the confined nuclei can be a target for similar nuclei, which can be generated and accelerated from the nearby electrode. The space between the electrode and internal lining can be filled to the extent needed with fusion fuel such as deuteron gas or heavy water.

As noted above, for two nuclei to fuse, the repulsive Coulomb barrier must be overcome, which occurs when two nuclei are brought close enough together where the short-range “nuclear forces” become strong enough to overcome the Coulomb force and fuse the nuclei. This energy barrier between two unconfined positive charges can be defined by the electrostatic potential energy:

$${U}_{coul} = k \frac{ {q}_{1} {q}_{2}}{r} = \frac{1}{4 π {ε}_{0}} \frac{{q}_{1} {q}_{2}}{r} \qquad ( Equation 1 )$$

Where k is the Coulomb's constant 8.9876×10⁹ N m² C⁻²; ∈₀ is the permittivity of free space; q₁, q₂ are the charges of the interacting particles; r is the interaction radius. A positive value of U is due to a repulsive force, so interacting particles are at higher energy levels as they get closer. A negative potential energy indicates a bound state (due to an attractive force).

Coulomb's barrier increases with the atomic numbers (i.e. the number of protons) of the colliding nuclei:

$${U}_{coul} = \frac{k {Z}_{1} {Z}_{2 } {e}^{2}}{r} \qquad ( Equation 2 )$$

where e is the elementary charge (1.602 176 53×10⁻¹⁹ C) and Z₁ and Z₂ are the corresponding atomic numbers.

The force between nuclei is initially repulsive, due to the Coulomb barrier, until a very small distance separates them, and then it rapidly becomes very attractive when the strong nuclear force takes over. Therefore, in order to surmount the Coulomb barrier, nuclei must get close enough for the attractive interaction between them to overcome the forces of repulsion, allowing the nuclei to bind or fuse together. Although there are many processes that could potentially lead to fusion of atomic nuclei, such as what happens due to huge gravitational forces in the sun, this can also be accomplished when the kinetic energy of the approaching nuclei overcomes the electrostatic repulsion of the Coulomb barrier as observed in such devices as neutron generators. In reality, the situation is helped by effects associated with quantum mechanics. Because of the Heisenberg Uncertainty Principle, even if the particles do not have enough energy to overcome the Coulomb barrier, there is a very small probability that a few of the particles pass through the barrier anyway. This is called barrier tunneling, and is the means by which many such reactions take place in stars. Nevertheless, because this process happens with very small probability, the Coulomb barrier represents a strong hindrance to nuclear reactions.

The terms “quantum mechanical tunneling”, “quantum tunneling”, “barrier penetration” or “barrier tunneling” as used herein each refer to the quantum mechanical phenomenon in which a particle (e.g. a nucleus) burrows or passes through a barrier that it classically could not surmount. For example, in classical physics an electron is seen as a particle that is repelled by an electric field as long as the energy of the electron is below the energy level of the electric field. However, in quantum physics this electron is known to have a finite probability of passing through the electric field. This phenomenon is used, for example, in the resonant tunneling diodes utilized in many electronic devices where fast acting diodes are needed. Quantum tunneling is one of the defining features of quantum mechanics and the wave-particle duality of matter.

To explain the scientific basis of the present invention, some basics of capacitor science should also be highlighted. A conventional electric capacitor is an electric energy storage device made up of two electrically conductive plates, or electrodes, separated by a dielectric. As defined herein, the term “dielectric” means an electrical insulator that can be polarized by an applied electric field. When a dielectric is placed in an electric field, electric charges do not flow through the material, as in a conductor, but only slightly shift from their average equilibrium positions causing dielectric polarization. If a dielectric is composed of weakly bonded molecules, those molecules not only become polarized, but also reorient so that their symmetry axis aligns to the field.

Capacitors are commonly used in a variety of electrical applications. For example, capacitors are used to tune the frequency of radio and television receivers, to eliminate sparking in automobile ignition systems, as energy storing devices, in electronic flashing units, and as filters in power supplies. The common capacitor functions on the basis of removal of electrons from a first electrode, resulting in the reverse phenomena of placement of electrons on the other electrode. This charge separation leads to a potential difference between electrodes and storage of electric energy by the capacitor.

The amount of capacitance of a capacitor is dependent upon the surface area of the electrodes, the distance separating the electrodes, and the permittivity of the dielectric separating the electrodes. A capacitor can have a variety of geometric constructions. A parallel plate capacitor, for example, is a capacitor in which the electrodes thereof are parallel plates separated by a dielectric having both a thickness and a permittivity selected to control the amount of capacitance of the capacitor. A cylindrical capacitor is a capacitor in which one of its electrodes is a first cylindrical hollow tube and another of its electrodes is a second cylindrical (and typically but not necessarily also hollow) tube concentric with the first cylindrical hollow tube. A spherical capacitor has one electrode in the form of a hollow sphere surrounding another electrode in the form of a solid or hollow sphere. The volume between the hollow sphere and the inner sphere contains a dielectric having a thickness and a permittivity selected to control the capacitance of the spherical capacitor.

The Capacitance (C) of a capacitor in units of Farad is defined as the ratio of the amount of charge (Q) in units of Coulomb placed on or removed from each of the electrodes, to the potential difference (V) in units of Volts (Joules/coulomb) between electrodes, or:

C=Q/V (Equation 3)

Here it is also noted that when a positive charge is brought near a negative charge, its electrical potential is reduced from a higher value to a lower value. Also, when a negative charge is brought near a positive charge its potential increases from a lower value to a higher value. This means that as positive and negative charges are brought closer to each other, the potential difference between them is reduced. This is the underlying definition of capacitance as presented in Equation 3, which also shows that for a constant value of charge Q, any increase in capacitance will result in reduction of the potential difference (V) between capacitor plates.

This phenomenon is easily observed when a capacitor is charged to a certain potential difference between its plates, resulting in placement of a given amount of charge on each plate. Now, if the potential supply source is disconnected and the plates are brought closer to each other, it is easy to measure the decrease in potential difference between the two plates as the plates are moved closer to one another. Thus, as noted above for Equation 3, when the opposing charges on the two plates are moved closer to each other by reducing the distance between the plates, the potential difference (V) between plates for the fixed value of charge (Q) is reduced, as the capacitance (C) is increased.

Electrical capacitance is a function of capacitor geometry, electrode plate material and the permittivity of the dielectric material between the two electrode plates. Capacitance increases with larger plate sizes, smaller distance between plates, higher permittivity of the dielectric material, and the use of higher surface area electrode materials. Therefore, when a capacitor is charged by a constant potential difference applied between its two plates, and if a dielectric is then placed between these plates or if the two plates are brought closer to each other, then the capacitance and the amount of charge on each plate increases. This means that at a constant potential (in energy per unit charge) the charge density is increased when the capacitance is increased. This is why historically capacitors were referred to as charge condensers.

Dielectric breakdown results in a spark of electricity passing from one electrode to the other (through the dielectric) as the charge stored on the plates is released. Before the occurrence of dielectric breakdown, if the dielectric is a solid, then the action of the electric field generated between the capacitor plates causes the displacement of centers of positive and negative charges in the electrically neutral dielectric. In the present invention, one dielectric that can be used is deuterium. The nucleus of deuterium, called a deuteron, contains one proton and one neutron, whereas the far more common hydrogen isotope, protium, has no neutron in the nucleus. Protium accounts for more than 99.98% of all naturally occurring hydrogen in Earth's oceans. Water in which deuterium has been highly concentrated with respect to protium is called heavy water.

If the dielectric is an electrolyte solution, oppositely charged ions within the electrolyte dielectric are free to move, such that positively charged ions move towards and concentrate on and adjacent to the negatively charged electrode, and vice versa. The attraction of ions on and adjacent to the capacitor plate (electrode) forms a spatial distribution of ions, known as a double layer.

Thus, electrolyte filled capacitors are typically referred to as Electric Double Layer Capacitors or EDLCs. The high capacitances of EDLCs are the result of an extremely small separation between the charged capacitor plates of these internal capacitors. In the charging cycles of these capacitors, equal amounts of positively and negatively charged ions in the electrolytic solution (e.g. saline water) are attracted to the capacitor plates, forming electrical double layers. EDLCs have increased electric capacitance compared to regular capacitors as a result of formation of these double layers of ions. A charged EDLC in effect includes two internal capacitors placed in series. Based on the science of EDLCs, one capacitor plate of these dual internal capacitors is typically a charged, highly conductive, high surface area electrode. This electrode can be made of material such as carbon aerogel or a carbon aerogel composite. The other “plate” is a concentration of ions of opposite polarity than the charge on high surface area electrode, positioned on and adjacent to the charged electrode in a double layer arrangement.

Carbon aerogels are unique porous materials consisting of interconnected nanometer-sized particles (3-30 nm) with small interstitial pores (<50 nm). This monolithic (continuous) structure leads to very high surface area (400-1100 m2/g) and high electrical conductivity (25-100 S/cm). The aerogel chemical composition, microstructure, and physical properties can be controlled at the nanometer scale, giving rise to unique optical, thermal, acoustic, mechanical and electrical properties. Among their many applications, carbon aerogels have found use as electrode materials in electrochemical devices.

The pore structure of aerogels is difficult to describe in words. The International Union of Pure and Applied Chemistry has recommended a classification for porous materials where pores of less than 2 nm in diameter are termed “micropores”, those with diameters between 2 and 50 nm are termed “mesopores”, and those greater than 50 nm in diameter are termed “macropores.” Silica aerogels possess pores of all three sizes. However, the majority of the pores fall in the mesopore regime, with relatively few micropores.

Optimized carbon aerogel is an ideal electrode material for an EDLC because of its high electrical conductivity, high specific surface area, and controllable pore size distribution. Capacitance increases as the distance between electrode plates decreases and the surface area of the electrodes increases. Because carbon aerogels have huge surface areas per unit mass or volume as a result of tiny pores, researchers have achieved capacitances as high as 104 F/g and 77 F/cm³. Other suitable materials for EDLC electrodes include activated carbon (also termed consolidated amorphous carbon (CAC)), activated charcoal, graphene, carbon nanotubes, and polymers such as polyacene.

In accordance with one aspect of the invention, the dielectric between capacitor plates can be an elemental gas such as hydrogen or deuterium gas, instead of an electrolyte solution. When such a gas dielectric is used, charging of the capacitor plates causes partial polarization of individual hydrogen atoms, such that there is weak alignment of these atoms in the direction of the electric field. However due to random thermal motion of these gas particles, this alignment is not complete. With increased electric field intensity, caused by increasing the potential difference between capacitor plates, the polarization and the consequent alignment increase. Once the dielectric strength of the hydrogen gas is reached, the bond between the electrons and the protons in the hydrogen atoms break and a spark is observed. This spark is the movement of negatively charged electrons from some of the hydrogen atoms towards the positively charged plate and the movement of the positively charged hydrogen nucleus (protons) towards the negatively charged plate of the capacitor. Upon contact with the negative electrode, the protons gain an electron and reconstitute the hydrogen atom and the electrons are absorbed by the positively charged plate. This process results in a resistive electric circuit allowing for flow of electricity by ionized gas particles between capacitor plates. If the potential difference between capacitor plates is reduced so that the electric field between plates could no longer ionize the gas, the flow of electricity stops.

The amount of energy stored in a capacitor is directly proportional to the amount of charge and the potential difference between plates. If the energy stored in a capacitor is designated as (U) in units of Joule, then:

U=(0.5)(Q)(V) (Equation 4)

The parameters and units are as defined earlier. Further it is noted that when two capacitors with capacities “C1” and “C2” are placed in series, the equivalent capacitance, or “Ceq” of the two connected capacitors, is defined by:

1/Ceq=1/C1+1/C2 (Equation 5)

This equation shows that when two capacitors are placed in series, the equivalent capacitance is effectively controlled by the capacitor having the lower capacitance. Further, because the amount of charge placed on two capacitors in series (herein denoted as “q”) is equal, the potential difference between the plates of such individual capacitors denoted as “V1” and “V2”, based on Equation 3 are defined as:

V1=q/C1 (Equation 6)

and

V2=q/C2 (Equation 7)

and therefore;

V1/V2=C2/C1 (Equation 8)

The total potential difference across the two capacitors connected in series is herein denoted as V is:

V=V1+V2 (Equation 9)

The above equations and particularly Equation 8 clearly indicate that when a capacitor with a very large capacitance is connected in series with another capacitor with very small capacitance, most of the potential difference applied across the two capacitors will occur across the capacitor with smaller capacitance.

Further, it is noted that a single conductive body could also be viewed as a capacitor, assuming that the second plate is located at infinity. As an example, a single spherical conductor in free space has a capacitance of:

C=4Π∈ₒr (Equation 10)

where ∈₀ is the permittivity of free space, equal to 8.854 E-12 Farads per meter, and ‘r’ is the radius of the sphere in meters. Here it is noted that that if the single isolated spherical conductor is fully immersed in a dielectric with dielectric constant of k, then the permittivity term ∈₀ in equation 10 is replaced by K ∈₀ indicating a proportional increase in capacitance.

It is also noted that as a general rule, charge densities on conductors are higher near sharp points. This point could be inferred from calculation of surface charge density of an isolated spherical conductor using Equations 3 and 10 and the surface area of sphere equal to 4Πr² yielding:

σ=∈ₒV/r (Equation 11)

in which σ is charge density in coulombs per unit area. Here too, when the single isolated spherical conductor is fully immersed in a dielectric with dielectric constant of k, then the permittivity term ∈₀ in equation 11 is replaced by k∈₀, indicating a proportional increase in surface charge density.

Equation 11 shows that at a constant potential V, the smaller the radius, the higher the charge density is. Based on Equation 11, it can also be inferred that if a certain amount of charge is placed on a conductive sheet that also has a sharp raised point, although the potential of all of the points on the plate will be the same after reaching steady state conditions (given the fact that after reaching steady state there is no movement of charges), the charge density at the sharp point wilt be much higher than the rest of the plate. Here it is very important to note that increased charge density at sharp points and on smaller spheres (compared to larger spheres) is the result of an increase in capacitance per unit surface area at sharp points and on small spheres. Using this phenomenon advantageously, one is able to pack charges in closer spacing with one another at the same potential (i.e. same voltage). Thus, it can be appreciated that charged nuclei can be packed closer to one another white at the same energy level per unit charge, if located at sharp points and/or on small spheres. Considering this, it can also be appreciated that capacitive storage of charges may be used to lower Coulomb repulsive forces between individual charges, effectively lowering the Coulomb barrier, as a result of higher capacitance per unit area.

Another physical phenomenon considered here is “barrier tunneling” as defined above. In combination with the capacitive confinement of ions and nuclei as described herein, barrier tunneling and the wave-particle duality of matter may provide for a few nuclei out of many to penetrate the coulomb barrier, of another, even though the requisite energy level is less than the barrier height. In such a situation, the probability of barrier tunneling (i.e. the odds of any given positively charged nucleus penetrating the coulomb barrier of another positively charged nucleus) is a function of particle mass, barrier width and the energy difference between the barrier height and particle energy. For a proton that is electrostatically forced towards another proton, with all other parameters being constant, then the difference between the energy of the proton and the energy needed to overcome the Coulomb barrier governs the probability of barrier tunneling. Therefore, the number of protons passing through the barrier in a given time span would be governed by the energy difference between each proton and the Coulomb barrier. In the present invention, it is proposed that the probability of Coulomb barrier penetration is increased by capacitive confinement and very close packing of positively charged nuclei within a small area, leading to a lowering of and eventual penetration of the Coulomb barrier.

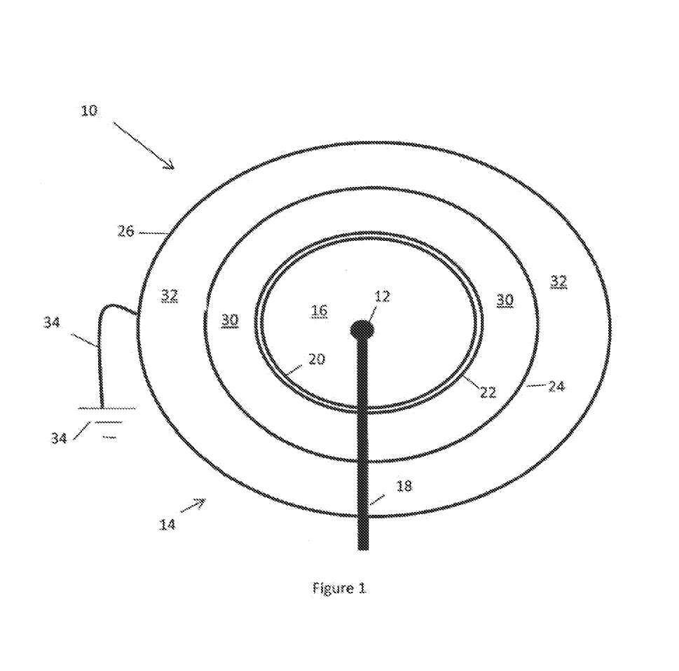

FIG. 1 illustrates a device according to the present invention for capacitive confinement of nuclei, such as deuteron nuclei. As shown, the device 10 includes a spherical electrode 12 centered within a hollow spherical shell 14. The shell 14 encloses an inner space 16 coaxially centered about the spherical electrode 12. An electrically insulated support 18 fixedly suspends the spherical electrode 12 within the spherical shell 14. A confinement layer 20, made of a high dielectric strength material, is located within the inner space 16 on the innermost surface of the spherical shell 14. A fusion reactive fuel such as heavy water or deuterium gas is typically contained within the inner space 16, between the confinement layer 20 and the electrode 12.

As illustrated, the spherical shell 14 is typically multi-layered, and includes an inner spherical plane 22, a middle spherical plane 24, and an outermost spherical plane 26. The inner space 16 is formed between the spherical electrode 12 and the inner spherical plane 22. The confinement layer 20 is typically located on the inside surface of the inner spherical plane 22. An inner layer 30, typically housing an electrically non-conductive medium such as boron nitride (which also has high heat conduction properties), is inserted between the inner spherical plane 22 and the middle spherical plane 24. An outer layer 32, typically housing an insulating medium such as insulating oil, is formed between the middle spherical plane 24 and the outermost spherical plane 26.

The insulated support 18 holds the central spherical electrode 12 in place and can be made of such insulating material as fused alumina or any other insulating material capable of withstanding the generated heat. This support stalk 18 typically has an electrical wire embedded in it that connects electrode 12 to the power source.

The confinement layer 20 is typically made of a non-conductive material with high dielectric strength and a high dielectric constant (e.g. silica aerogel) with hole or pore sizes in the order of millimeters to micro-meters. There is an electrical wire passing through the insulated support 18 which connects the spherical electrode 12 to a direct current, positive polarity, high voltage electric power source (not shown). The outermost spherical plane 26 is typically metallic, encloses the outer layer 32, and is connected to electric ground 34 by a wire 36, as shown. Thus, electrical interconnections are present between an electric power source leading to the insulated support 18, the spherical electrode 12, and earth ground 34. The metallic outermost spherical plane 26 also acts as heat exchange medium between the device 10 and the outside environment. As such, it is envisioned that the device 10 of the invention can be placed in a water container or tank for generation of steam which can power a turbine. Alternatively, housing for the apparatus can accept water for the generation of steam to power a turbine.

The outermost spherical plane 26 is typically equipped with outlet and inlet passages (not shown) connecting to the inlet and outlet of a pump, respectively. Such a pump can be used to circulate the insulating oils of the outer layer 32, and can be part of a de-airing and heat exchanging system for these oils.

The inner layer 30 has multiple functions. First it should be nonconductive and act as a dielectric, to allow for accumulation of ions without discharging ions to the outside environment. As such, and in combination with the outer layer 32, the thickness of the inner layer 30 should be determined based upon the dielectric strength of the material used and the potential difference applied across it. Layers 30 and 32 together should limit electrical leaks or ion flow. Second, the inner layer 30 functions as a support layer for the confinement layer 20. In this function it preferably has low thermal expansion and high mechanical strength, to withstand the thermal loading caused by fusion reactions taking place on and in the confinement layer 20. The inner layer also preferably has high thermal conductivity, to convey the heat generated to the outside environment. As a non-limiting example, boron nitride (sintered or fused) can be used for the inner layer 30. The inner layer 30 in some cases could also have a fine interconnected porosity, to allow fusion products (e.g. helium nuclei generated from fusion of deuteron nuclei) to flow out through it, and enter the outer layer 32. This feature would be used in cases in which the materials used for confinement layer 20 have extremely high dielectric strength ranging in many thousands of megavolts per meter.

The outer layer 32 is the main insulating layer and can be made of high dielectric strength oils similar to the ones used in high voltage transformers. The outer layer 32 also has multiple functions. For example, the outer layer bears the main burden of insulation of the potentials applied to electrode 12. It also conveys the heat generated from the inner layer 30 to the outermost spherical plane 26, which is the main cover of the device. The outer layer 32 also preferably allows for transfer of fusion products passing from the inner layer 30 to the outermost spherical plane 26, where the products such as helium nuclei can gain an electron and form helium gas. Finally, the outer layer 32 preferably allows for removal of fusion products such as helium gas by such means as de-airing (partial vacuum application). For example, a circulation pump circuit can be employed for circulating and de-airing the outer layer oils.

The spherical shape is just one representative shape for the apparatus of the present invention. The spherical shape optimally allows for all the features (confinement and collision) required to accomplish the method of the invention. However, any shape that forms a confined space allowing an exposed anode to come in contact with the gas or liquid fuel can also work for confinement features. As a non-limiting example, the electrode and shell and inner planes and layers can be cylindrical, doughnut-shaped, or any other shape compatible with the intended purpose of the invention. The principals explained herein are applicable to many enclosed shapes forming a confined space and allowing an exposed anode to come in contact with the gas or liquid fuel, including cylindrical shapes or even parallel plate arrangement, as long as one plate of the capacitor is insulated by a non-conductive layer in accordance with teachings of the invention.

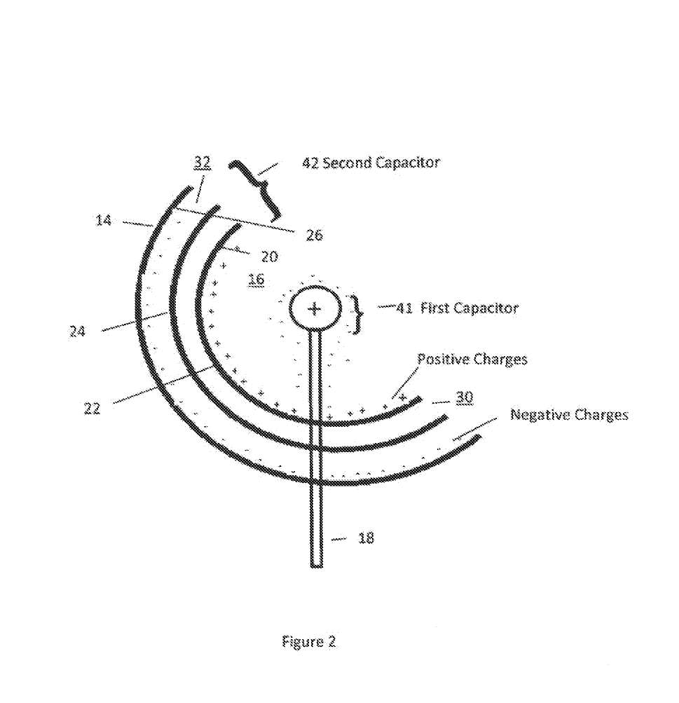

In one embodiment, illustrated in FIG. 2, the inner space 16 can be filled with heavy water (D₂O) as the fusion reactive filet, and the spherical electrode 12 can be a high surface area, high electrical capacitance electrode such as a carbon aerogel electrode. In this arrangement, if the electrode 12 is energized to any voltage level, and the electrical insulation capabilities of the non-conductive layers 20, 30 and 32 are high enough to prevent any appreciable exchange of electric charge between the inner space 16 and the outside environment, then there ill be a build-up of electrical potential within the heavy water in the inner space 16. This increased electrical potential in the inner space 16 will be due to the collection of ions of opposite polarity to the charge supplied to the electrode 12. Consequently, if the electrode 12 is positively charged as illustrated, then positive ions will now gather on and in close proximity to the confinement layer 20. This phenomenon is due to the charge imbalance imposed on the electrolyte solution.

Still looking at FIG. 2, when the central spherical electrode 12 is positively charged, then negative ions are attracted to the electrode 12 from the heavy water. These negatively charged ions will gather on and in close proximity to the electrode 12, as illustrated, forming an electric double layer. The imbalance in charge distribution in the electrolyte solution in the inner space 16, caused by attraction of its negative ions to electrode 12, will result in repulsion of positive ions (D+ ions) from the liquid and their collection at the surface of the confinement layer 20 near the outer edge of the electrolyte solution in the inner space 16. This results in the formation of two capacitors in series. The first of these capacitors, referred to as the inner internal capacitor 41 having a capacitance of “C1”, is formed between electrode 12 and the double layer of ions collected on and in close proximity to it, and the second capacitor, referred to as the outer internal capacitor 42 with capacitance of “C2”, is formed by the ions collected on and in close proximity to the confinement layer 20 and the induced charges on the inner surface of the metallic outermost spherical plane 26. Layers 20, 30 and 32 serve as the dielectric between these two capacitor plates. The available surface area of the inner internal capacitor 41 will be high, and the charge separation will be extremely small, resulting in much higher capacitance as compared to the outer internal capacitor 42.

The amount of charge moved onto the central spherical electrode 12 is governed by the equivalent capacitance of the two capacitors thus formed. As a result, when the inner internal capacitor 41 and the outer internal capacitor 42 are connected to each other in series through the electrolyte in inner space 16 between them, the equivalent capacitance of the system, “Ceq”, defined by Equation 3 (1/Ceq=1/C1+1/C2), will be very low and close to the small value “C2” of the outer internal capacitor 42. Furthermore, based on Equation 6 (V1/V2=C2/C1) and Equation 7 (V=V1+V2), and also based on the large difference between the capacitance “C1” of capacitor 41 and capacitance “C2” of capacitor 42, the majority of any potential applied to electrode 12 will be seated across the outer internal capacitor 42 and only a very small fraction of it will be seated across the inner internal capacitor 41. Consequently, there will be very little potential difference between electrode 12 and electrolyte solution in space 16. This means that we now have a capacitor between positive ions on layer 20 and the electrons on the interior surface 26 of shell 14.

As a numerical example, if electrode 12 is made up of carbon aerogel and is placed in space 116, which is filled with heavy water (D₂O), its capacitance and therefore that of the inner internal capacitor 41 can be assumed to be in the order of 10 Farads. Now if the capacitance of the outer internal capacitor 42 is in the order of 50.0 micro-micro farads (μμF), the equivalent capacitance of the equivalent hydro-electrochemical capacitor based on Equation 3 would for all practical purposes equal to 50 μμF. Therefore, if the potential applied to the electrode 12 is 10 volts, based on Equation 1 (C=Q/V) the charge that would move on to electrode 12 will be equal to 500 E-12 coulombs. Now with reference to Equation 4 (V1=q/C1) and Equation 5 (V2=q/C2), and noting that the charge on both these capacitors will be equal, it becomes apparent that the potential seated across the outer internal capacitor 42 will be practically equal to 10 volts and the potential seated across the inner internal capacitor 41 will be 50.0 E-12 Volts, which is extremely small and practically negligible. Thus, if it is correctly assumed that no electrode reaction takes place between the central electrode 12 and the heavy water surrounding it in the inner space 16 until the potential difference between them reaches about one volt, then it could be concluded that a very large potential of up to 200 E+09 volts could be applied to electrode 12 without electrode reactions. This means that until the potential applied to electrode 12 reaches 200 E+09 volts, the potential difference between electrode 12 and the electrolyte in space 16 will not approach the voltage required to effect electrode reactions and there will be no Oxygen gas produced on the surface of electrode 12, interfering with operation of the device. Such distribution of potential differences between a high capacitance electrode placed in an electrolyte and placed in an insulated container have been experimentally confirmed as reported in the above reference Published U.S. Patent application #2012/0097541. These tests have shown negligible potential between the high capacitance electrode and the surrounding electrolyte while all of the applied potential was measured between the electrolyte and the electrical ground.

In another embodiment of the invention, the inner space 16 can be filled with an elemental gas such as hydrogen or deuterium gas, and electrode 12 can be a metallic, low capacity electrode. With this embodiment, the distribution of potentials between the two capacitors 41 and 42 will be much closer to each other, as can be inferred from the same rationale used for the electrolyte case above. This means that if we assume the capacitance of the low capacitance, metallic electrode 12 (capacitance of the inner internal capacitor) to be 1.0 μμF for diameter of about 2 centimeters and the capacitance of the outer internal capacitor to be 50 μμF, then if we apply 100 volts to electrode 12 (with respect to ground), then the potential difference between electrode 12 and the gas surrounding it will be about 98 volts, and the potential difference between the gas and electric ground will be slightly less than 2 Volts. Thus, in this scenario, if electrode 12 is charged to a high potential, the potential difference between electrode 12 and the deuterium gas surrounding it in the inner space 16 will occur at much higher ratios of the potential applied to electrode 12. This way, if the potential applied to electrode 12 is positive, the potential required to cause ionization of some of the gas atoms will be much lower. For the above example, and assuming the diameter of electrode 12 to be two centimeters, by application of a positive potential exceeding about 21,000 volts, the potential difference between electrode 12 and the gas surrounding it will reach exceed 20,000 volts resulting is an electric field intensity of 2000 volts/mm that is the potential needed to cause the ionization of hydrogen gas. This process can cause electrons of hydrogen atoms to be absorbed by the central electrode 12, and the repulsion of the positively charged nuclei of the same atoms to the outer edge of the inner space 16 and onto the confinement layer 20 when the applied potential is high enough to cause sufficient ionization of the gas in space 16 and breakdown of the gas dielectric. Under this condition, and with application of potentials exceeding 21000 volts, there will be a positive ion concentration formed at the confinement layer 20 forming a first plate of the outer internal capacitor 42, the second plate being the induced charges on the inner surface of outermost spherical plane 26, with layers 20, 30 and 32 acting as the dielectric between these two capacitor plates. It is also noted that ionization of hydrogen gas could also occur at lower voltages, if the surface of electrode 12 is coated with a catalyst such as platinum black.

With this configuration, as a potential difference many orders of magnitude beyond the ionization potential of the hydrogen gas is applied to electrode 12, the outer internal capacitor 42 formed at the confinement layer 20, having a capacitance approximated by Equation 10, will in time be charged to a potential differing from the potential applied to electrode 12 only by the potential required to break the dielectric strength of the gas in space 16, as this electrode will no longer act as a capacitor and will be a resistive element in this circuit. Here it is noted that due to the considerable thickness of the inner and outer layers, 30 and 32, even considering typical values of dielectric constants for the materials they house, the capacitance of a single plate spherical capacitor at the confinement layer 20 (even if totally insulated) will be rather close to that of the capacitance of the spherical capacitor 42.

For both embodiments above, whether the inner space 16 is filled with an electrolyte such as heavy water or a gas such as deuterium, the penetration of the positively charged nuclei congregated into the pore or hole passages of the confinement layer 20, result in higher charge density than the ions not penetrating these pores or holes, as indicated by Equation 11.

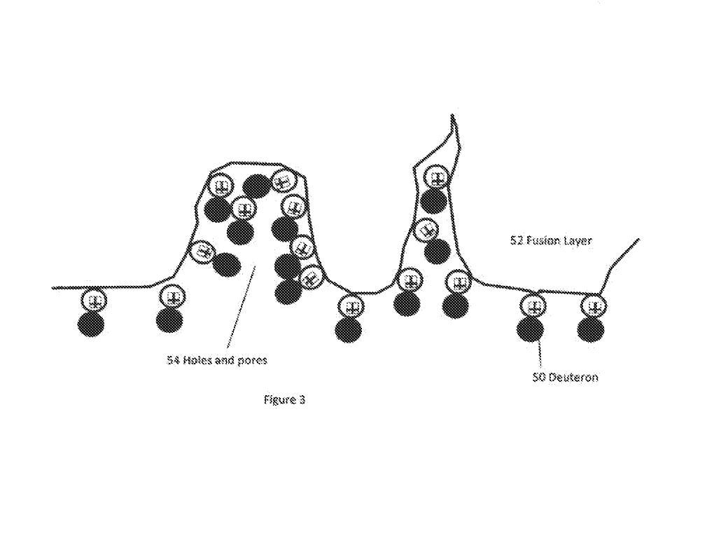

As illustrated FIG. 3, positively charged nuclei 50 can become tightly packed within the pores and holes 54 of the material 52, such as calcium-copper-titanate, which makes up the confinement layer. As an example, if the potential applied to electrode 12 in either case is in the order of 60,000 volts higher than the breakdown voltage of the gas in space 16, and the diameter of the holes 54 are in the order of 0.5 millimeters, and if the material 52 of the confinement layer 20 has a dielectric constant of 1250 (Barium titanate with a dielectric strength assumed to exceed 120 MV/m), the charge density in these passages 54 (based on Equation 11) will be such that the spacing between nuclei 50 will be in the order of 3.47 angstrom which is 6.55 times the Bohr radius. That is, under such conditions the spacing between two nuclei will be almost only 6.55 times the typical distance between the electron and the nucleolus of hydrogen atom. Since the spacing between positively charged nuclei will be smaller with increased voltage levels, it can be appreciated that with higher applied potentials, the spacing between positively charged ions 50 will be less. With this system, the probability of one nucleus penetrating the Coulomb barrier of another will be higher with increase applied potential and with smaller diameter pores, resulting in the increased probability of nuclear fusion and release of fusion energy.

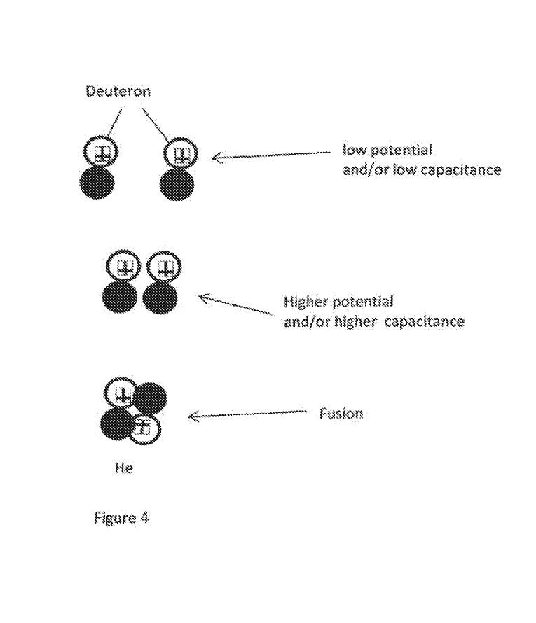

FIG. 4 illustrates two nuclei, within the close packing conditions created by the device and method of the present invention, in the process of fusion. As indicated, close packing of the positively charged nuclei is augmented by an increase in voltage and by the pores and passages of the confinement layer, leading to a higher probability that the Coulomb barrier will be overcome and fusion reactions will occur. Fusion of nuclei creates fusion reaction products such as Helium and gamma rays, as illustrated.

The higher surface charge density caused by penetration of positively charged nuclei into the small diameter pores/holes of the confinement layer 20 occurs because each pore or hole becomes a spherical or semi-spherical capacitor in itself. In each pore/hole, the capacitance per unit area increases with reduction in pore/hole size. Thus, with reducing pore/hole size, the resulting charge density per unit surface area will be higher (C/A=K ∈ₒ/r for an isolated single plate spherical capacitor immersed in a dielectric material with dielectric constant of K). As a result, the charge density at a constant potential will also be higher with smaller pore/hole sizes. If Equation 11 (σ=∈ₒ V/r) is modified to account for the effect of the dielectric constant of the material of the confinement layer 20 (σ=K∈ₒ V/r), then the ratio V/r is equal to the electric field intensity at the surface of the confinement layer 20. The maximum value the electric field strength can reach (which is the ratio V/r) depends upon the dielectric strength of the material used for the confinement layer 20 (dielectric strength being defined as the maximum electric field intensity a dielectric material can withstand before it breaks down and a discharging spark occurs between capacitor plates). Further, at a given electric field intensity (V/r), the higher the dielectric constant K of the material, the higher the capacitance per unit surface area of the capacitor formed in each pore/hole, and the higher the resulting charge density. In the case of small pores, if the intensity of the electric field exceeds the dielectric strength of the material, the material will fail and disintegrate.

Stated differently, one plate of the outer internal capacitor 42 can be the inner surface of the confinement layer 20, and the second plate can be the inner surface 26 of the shell 14. Here the charge density on layer 20 will be governed by modified Equation 11 (σ=K∈ₒ V/r) in which “K” is the equivalent dielectric constant of layers 20, 30 and 32, “V” is the voltage of capacitor 42, and “r” is the radius of the inner space 16. However, as noted above, the electric behavior of the pores/holes on the surface of the confinement layer 20 can be considered as spherical or semi-spherical single plate capacitors having a very small diameter, for which the charge density can also be calculated using modified Equation 11 (σ=K∈ₒ V/r). In the case of these pores, “K” is dielectric constant of the confinement layer 20 and the voltage (V) is the same as that of capacitor 42, but “r” is the radius of the pore or hole. Thus, while the ions within the pores/holes will be at the same voltage as ions concentrated on the surface of layer 20, the charge density within the holes will be higher than outside of them. As the diameter of the pore or hole is reduced under constant applied potential, the charge density and the electric field intensity imposed on the material constituting the outer wall of the ionic capacitor within the pore/hole also increase. If the hole or pores become too small, the material of layer 20 may disintegrate under the influence of the generated electric field.

On a theoretical level, the phenomena of capacitive confinement of ions can also be understood to occur through the formation of “induced surface charges” in the dielectric. As noted earlier, when a solid dielectric is placed between the plates of a capacitor, the action of the electric field generated between these plates leads to polarization of the dielectric and a shift in the center of positive and negative charges in the dielectric, even though the whole dielectric remains electrically neutral. The result of this polarization at an atomic level leads to formation of dipole moments and establishment of an electric field within the material opposing the original electric field. This is equivalent to formation of what is called induced surfaces charges with opposite polarity with respect to the charges on the capacitor plate adjacent to them. The effect of formation of these induced surface charges of opposite polarity near the charges on the original capacitor plates is to lower the potential of the charges on the capacitor plate, allowing them to pack more closely. Therefore, each positively charged nucleus will be at a much lower energy level. Given the close packing of ions on the surface and in the holes of the confinement layer 20, positively charged nuclei will behave as if their charge is much lower.

Based on the above, it could be concluded that the higher the dielectric strength, the higher the dielectric constant, and the smaller the hole size of the confinement layer material, the lower the potential energy of individual charges will be, resulting in closer packing at a given voltage. Indeed, this is equivalent to reducing the Coulomb repulsive forces between these nuclei, resulting in a lower energy required to overcome the Coulomb barrier. Due to this lowering of the Coulomb barrier height (i.e. lowering of the amount of energy needed to overcome the Coulomb barrier), the probability of successful barrier tunneling resulting from collisions caused by natural thermal kinetic energy of these charges is increased.

Here it is noted that in order to have a successful fusion process, the rate of reaction will have to be controlled. Thus, it is preferable that the combination of pore size in the confinement layer 20 and the applied voltage to electrode 12 is such that the barrier tunneling rate is low enough so that the generated heat and mechanical and heat stresses would be manageable by the structure of the apparatus. That is, if the electrical potential for a given pore size is increased to a level wherein the heat generated damages the structure of the device, it would not be a good engineering design. Also, it is preferable that the generated heat can be utilized for the generation of steam. One option for recovery of the generated heat may be placement of the entire apparatus in a water container, in which the water is heated through the outer surface of shell 14.

Further, in order for this process to continue for extended periods, the fusion products need to be removed from the pores of the confinement layer 20. This can be accomplished by stopping the operation and vacuuming the device. In the case of extremely high dielectric strength material limiting the thickness of the confinement layer 20, the material of the inner layer 30 can be chosen such that it would have much larger pores in comparison to the pores of the confinement layer 20. This way, the fusion products (e.g. helium nuclei) can gradually migrate to and penetrate the inner layer 30, and then continue to move outward to the outer layer 32. Upon contact with outermost spherical plane 26, each of these positively charged helium nuclei will gain an electron and change to helium gas, which can be removed when the insulating oils of the outer layer 32 are circulated by action of a pumping and gas extraction system.

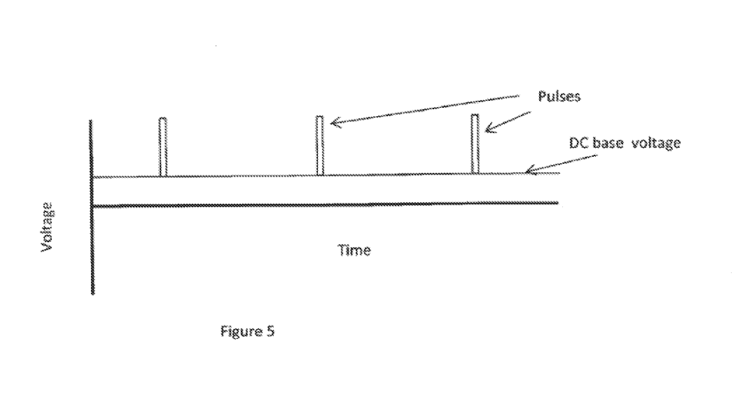

Given the above, and because capacitors are energy storing devices, it can also be postulated that kinetic energy can be imparted to individual positively charged nuclei, and these nuclei can then be “fired” or otherwise propelled towards nuclei restrained on the confinement layer. This firing of nuclei at the confinement layer can be another means of breaking through the Coulomb Barrier. That is, pulse charging and firing of positively charged nuclei from the electrode 12 towards the confined nuclei at the confinement layer 20 can augment the probability of penetrating the Coulomb barrier. See FIG. 5, which is a graph showing pulses of high voltage administered over time in order to generate and accelerate nuclei towards the confinement layer. Pulse charging of electrode 12 with very high voltages only limited by the dielectric strength of insulating layers) beyond the voltages used to form high density charge distribution in and on layer 20 can be used as a means of accelerating positive ions from the surface of the central electrode 12 towards the ions concentrated at the outer limits of the inner space 16. Pulse charging thus provides a means of penetrating the Coulomb Barrier by using the impact energy between ions.

It is important to note that, once the outer internal capacitor 42 is fully charged, there will be no electric field generated towards the inner space 16 by charges at the confinement layer 20. Therefore, charges on the confinement layer will not resist the nuclei fired at them, such that no Coulomb repulsive forces will exist and thus there will be no Coulomb barrier to overcome. Stated differently, electrode 12 and the confinement layer 20 can constitute conditions of potentials as in a classical electrostatic generator, envisioned by Lord Kelvin and utilized as an accelerator by R. J. Van de Graaff. As a result, when some amount of positive charges are placed on electrode 12, regardless of the amount of charges present on layer 20, the potential of charges on electrode 12 will be higher than those on layer 20. Thus, if the dielectric strength of the gas in the inner space 16 is assumed to be a given amount denoted as “P”, when the potential applied to electrode 12 exceeds the value of “P”, the now ionized gas in the inner space 16 will allow any charge added to electrode 12 to flow to layer 20 until the potential of charges on layer 20 approach the potential of electrode 12 minus “P”. Once this potential difference is reached, the flow of charges from electrode 12 towards layer 20 will stop.

As a non-limiting example, the potentials shown on FIG. 5 can be a base potential of 10 KV, and a pulse charge can be delivered up to 100 KV. Now, if the potential difference needed to initiate ionization and ion flow is 20 KV, the charges on layer 20 are maintained at a minimum potential of 30 KV, and pulse charging is performed up to 80 KV higher (100 KV), then as pulse charging is applied for a sufficient amount of time (equivalent to say about 5 time constants), the potential of charges on the confinement layer 20 will increase until the potential difference between these charges and the potential imposed on electrode 12 reaches 20 KV. At this point, there is no further ionization of gas in the inner space 16. At the end of this pulse loading, the potential of charges on layer 20 will be 80 KV (100-20). Now if the potential imposed on electrode 12 is dropped to 10 KV, there will now be a potential difference of 70 KV between charges on surface 20 and electrode 12, causing the flow of the nuclei on layer 20 to electrode 12. If sufficient time, for example about 10 time constants, is allowed for this discharging, the potential of charges on layer 20 will gradually drop to about 30 KV, at which time the gas in space 16 will no longer be ionized as the potential difference between charges on layer 20 and electrode 12 will once again be 20 KV and the reverse flow of charges stop. The cycle of pulse charging followed by discharging could then be repeated.

Based on the above, it can be appreciated that the nuclei fired from electrode 12 are acting under a potential difference that facilitates their movement towards charges present on layer 20 and not oppose them. In other words, there will now be no repulsion between these charges, i.e. the coulomb barrier in the direction from the central electrode 12 towards the confinement and fusion layer 20 will effectively not exist.

In order to reduce the (probability of collisions occurring between fired ions and non-ionized gas molecules still present in the inner space 16, the number of total gas molecules/particles should be limited by lowering the pressure in the inner space 16. This can be accomplished by creating a vacuum in the inner space within the hollow shell before filling it with a sufficient amount of fusion reaction fuel to carry out the process, the amount needed being determined by the intended fusion reaction rate. That is, to affect a given rate of fusion reaction, the number of total gas atoms in the inner space 16 should be roughly equal to the total number of nuclei confined on and in the pores of layer 20 at maximum applied potential. As a non-limiting example, the fusion reactive fuel can be at a predetermined pressure ranging from about 0.0001 to about 0.1 Torr.

When the potential applied to electrode 12 is suddenly, and in a pulsed manner (such as in square wave shape as shown in FIG. 5), increased by a certain high voltage beyond the steady state DC voltage previously applied to it, each hydrogen isotope atom contacting electrode 12 will be ionized and its nucleus will gain a potential energy equal to the charge of the atom nucleus (equal to 1.602 176 53×10⁻¹⁹ Coulombs) times the voltage. The values of potential energy achieved by each nucleus could easily reach many MeVs, exceeding the energy values typically cited as being required for penetration of the Coulomb barrier, as a function of applied potentials. The charged hydrogen isotope nucleus will then accelerate towards the confinement layer 20 with almost equal kinetic energy within the relative vacuum in space 16. If such a charged particle collides with any nuclei on and in the pores of the confinement layer 20, its collision energy will be very close to the gained potential energy at electrode 12. Because the nuclei on and in the pores and holes of layer 20 will be stationary and also exhibiting much lower equivalent charge, and because the electric field generated by these charges will point outward away from the inner space 16, such collisions will not have to overcome repulsive Coulomb forces. As a result, the probability of fusion between these nuclei will be much higher than if both particles were to be fired towards each other in free space.

Because the invention disclosed herein is based on capacitors, the rate of ion flow is a function of the Time Constant of the circuit. As the time constant is defined as capacitance multiplied by resistance (RC), the rate of ion transfer will be higher if the Time Constant is lower. Further, it is noted that as the nuclei firing system contemplated are basically a resistance/capacitance (RC) circuit, the generated currents could be maximized by increasing the frequency of the voltage pulsations. The expected operating frequencies are up to and including radio frequency ranges.

The present invention proposes that if tightly packed, positively charged hydrogen isotope nuclei are capacitively confined in an insulated container they will naturally repulse each other and accumulate on the periphery, or the confinement layer 20, of the internal volume of the container. The combination of this phenomenon with a confinement layer having a surface with very small diameter holes or pores for the nuclei to enter and be confined within, provides extremely tight packing of charged nuclei. In addition, these nuclei can then be fired upon by pulse charging of the central electrode, providing a high probability of nuclear fusion.

The invention can include the process of capacitive confinement of hydrated ions of positive polarity on a dielectric layer, forming the outer edge of the ion-containing liquid by capacitive absorption of ions of opposite polarity to an electrode also placed in the ion containing solution, thus forming two capacitors in series. Further, the invention teaches that manipulation of the charge density and voltage of ions capacitively confined on the dielectric layer can be accomplished by controlling the ratio of the capacitance of the capacitor formed at the ion absorption electrode and the capacitor formed by the confound ions on the dielectric layer, and a second plate of the confound ions and dielectric layer being on the outside of the liquid and dielectric, and by applied voltage between said electrode and ground. The liquid can be replaced by a gas, and the electrode can be replaced by a low capacitance electrode, thus resulting in stripping of electrons from the gas and forming a resistive circuit for transfer of ions to the surface of the dielectric forming the outer edge of the gas. The invention also teaches the process of using high frequency voltage variations and inherent properties of an RC circuit formed between the low capacitance central electrode, the gas as fusion reaction fuel, and the capacitance of the capacitor formed at the insulation layer forming the outer edge of the container, to increase the intensity of ionic current and the ions fired at the confound ions.

Yield Calculation

A rather conservative and rough estimate of potential yield of a fusion power generating device based on this invention, and with a view to FIGS. 1 and 2, is now presented. Assumptions: Diameter of electrode 12=18 mm; Diameter of surface 20=20 mm; Base applied DC potential=85 KV; Pulsing potential=100 KV; Minimum voltage on layer 20=90 KV; Maximum voltage on layer 20=95 KV; Material of layer 20: Barium Titanate with a dielectric constant of 1250 and dielectric strength of 120 MV/m and with holes on the inner surface having a diameter of about 0.67 mm.

Based on the above assumed parameters and the modified equation 11, the average charge density on layer 20 will be about 1.3275 coulombs per square meters, equivalent to 8.3 E+18 individual positively charged hydrogen isotope nuclei per square meters with an average spacing of 3.47 Angstroms. Now if we assume a generated current of 10 Amperes and if it is assumed that fusion will take place for every direct hit at a thermally vibrating nuclei with an equivalent area of about 20 E-24 square meters, it could be expected that from every 6135 ions fired from electrode 12 towards surface 20, there will be one hit. This results in an average about 800 E+15 hits per second, resulting in an average output energy of 2.18 MW when it is assumed that each hit would yield 17 Mega electron volts of energy (D-T reaction). The maximum input energy calculated based on pulsating wave potential of 15 KV and a current of one Ampere is 15 KW. This means that the yield could be estimated at over 145. Here it is stressed that this calculation is an estimate intended for demonstrational purposes and the required design and operating conditions are not optimized.

While the present invention has been illustrated by the description of embodiments and examples thereof, it is not intended to restrict or in any way limit the scope of the appended claims to such detail. Additional advantages and modifications will be readily apparent to those persons of ordinary skill in the art. Accordingly, departures may be made from such details without departing from the scope of the invention.

What is claimed is:

1. An apparatus for penetrating the Coulomb Barrier, comprising:
a) an electrode;
b) a hollow shell enclosing an inner space around the electrode;
c) a confinement layer made of a high dielectric strength material, the confinement layer located within the inner space on the inside surface of the shell;
d) a fusion reactive fuel contained within the inner space;
e) a direct current, positive polarity, high voltage electric power source; and
f) electrical interconnections for connecting the electric power source to the electrode, and for connecting the hollow shell to earth ground.

2. The apparatus of claim 1, wherein the electrode and the hollow shell are spherical, with the electrode being centered within the hollow shell.

3. The apparatus of claim 2, further comprising an electrically insulated support fixedly suspending the spherical electrode within the spherical shell, wherein the spherical shell is multi-layered and includes an inner spherical plane, a middle spherical plane, and an outermost spherical plane, and wherein the inner space is formed between the spherical electrode and the inner spherical plane, the confinement layer is located on the inside surface of the inner spherical plane, an inner layer is formed between the inner spherical plane and the middle spherical plane, and an outer layer is formed between the middle spherical plane and the outermost spherical plane.

4. The apparatus of claim 3, further comprising a non-conductive medium contained within the inner layer; and an insulating medium contained within the outer layer.

5. The apparatus of claim 1, wherein the confinement layer has a plurality of small pores or holes on the surface thereof.

6. The apparatus of claim 5, wherein the confinement layer is made of non-conductive material preferably having pore or hole sizes in the millimeters to micrometers scale range.

7. The apparatus of claim 1, wherein the electrode is made of a material which provides a high surface area, high electrical capacitance, and wherein the fusion reactive fuel is heavy water.

8. The apparatus of claim 7, wherein the electrode is made of a carbon aerogel material.

9. The apparatus of claim 1, wherein the electrode is composed of low capacitance material.

10. The apparatus of claim 1, wherein the fusion reactive fuel is any gas suitable as a fusion fuel.

11. The apparatus of claim 1, wherein the fusion reactive fuel is heavy water.

12. The apparatus of claim 1, wherein the fusion reactive fuel is at a predetermined pressure from about 0.0001 to about 0.1 Torr.

13. A method of confining nuclei for the purpose of penetrating the Coulomb barrier, the method comprising:
a) providing a confinement layer made of a high dielectric strength material, the confinement layer lining an inner space within a hollow shell;
b) filling the inner space with a fusion reactive fuel; and
c) charging an electrode seated within the shell with a direct current, positive polarity, high voltage electric power source, wherein the shell both encloses the inner space and is centered about the electrode, charging of the electrode causing confinement and packing of charged nuclei on the confinement layer.

14. The method of claim 13, wherein the hollow shell is multi-layered and spherical, the shell including an inner spherical plane, a middle spherical plane, and an outermost spherical plane, and wherein the inner space is formed between the spherical electrode and the inner spherical plane, an inner layer is formed between the inner spherical plane and the middle spherical plane, and an outer layer is formed between the middle spherical plane and the outermost spherical plane.

15. The method of claim 13, further including the step of repeated pulse charging of the electrode with high voltage following the initial charging step, thereby firing electrons towards the confinement layer.

16. An apparatus for capacitive confinement of nuclei as a means of penetrating the Coulomb Barrier, comprising:
a) A spherical electrode;
b) a multi-layered hollow spherical shell enclosing an inner space coaxially centered around the spherical electrode, wherein the spherical shell includes an inner spherical plane, a middle spherical plane, and an outermost spherical plane, and wherein the inner space is formed between the spherical electrode and the inner spherical plane, an inner layer is formed between the inner spherical plane and the middle spherical plane, and an outer layer is formed between the middle spherical plane and the outermost spherical plane;
c) an electrically insulated support suspending the spherical electrode fixedly and concentrically within the spherical shell;
d) a confinement layer made of a high surface-area material, the confinement layer located within the inner space on the inside surface of the inner spherical plane;
e) a fusion reactive fuel contained within the inner space;
f) a non-conductive medium contained within the inner layer;
g) an insulating medium contained within the outer layer;
h) a direct current, positive polarity, high voltage electric power source; and
i) electrical interconnections for connecting the electric power source between the spherical electrode and earth ground.

17. The apparatus of claim 16, wherein the confinement layer is made of a non-conductive material having a plurality of small pores or holes on the surface thereof, the pore/hole sizes being in the order of millimeters to micrometers.

18. The apparatus of claim 16, wherein the spherical electrode is made of a material which provides a high surface area, high electrical capacitance, and wherein the fusion reactive fuel is heavy water.

19. The apparatus of claim 18, wherein the spherical electrode is made of a carbon aerogel material.

20. The apparatus of claim 16, wherein the electrode and shell and inner planes and layers, instead of being spherical, are any shape that forms a confined space allowing an exposed anode to come in contact with the gas or liquid fuel, including cylindrical shapes.
